(19) United States
(12) Patent Application Publication
(10) Pub. No.: US 2025/0010672 A1
(43) Pub. Date: Jan. 9, 2025

(54) HITCH HOOK

(71) Applicant: James E. Davies, III, Atwater, OH (US)

(72) Inventor: James E. Davies, III, Atwater, OH (US)

(21) Appl. No.: 18/796,691

(22) Filed: Aug. 7, 2024

Related U.S. Application Data
(63) Continuation-in-part of application No. 18/428,374, filed on Jan. 31, 2024.
(60) Provisional application No. 63/512,607, filed on Jul. 7, 2023.

(51) Int. Cl. B60D 1/58; B60D 1/06

(52) U.S. Cl. CPC B60D 1/58; B60D 1/06

(57) ABSTRACT

Provided in this disclosure is a hitch adapter having a base plate and a latch plate. The base plate includes a plurality of anchor points and first and second semicircular cutouts. The base plate also includes a plurality of connection points disposed radially about a center point. The latch plate includes a latch semicircular cutout and a plurality of connection points—equal to the quantity of base plate connection points and corresponding to the locations of the base plate connection points. The latch plate is disposed atop the base plate.

### I. BACKGROUND

### A. Technical Field

The present disclosure pertains to the field of truck and trailer hitches. More particularly, the disclosure pertains to the field of hitch adapters for use with ball hitches including but not limited to 5^{th} wheel ball hitches.

### B. Description of Related Art

5^{th} wheel balls, present on truck beds, have been used in a variety of ways, with different adapters, hitches, and attachments. The ball pin allows a user to affix heavy trailers and pull large amounts of weight with their truck, using the ball pin as a connection point.

However, many of these hitches and adapters are specifically designed to fill a particular niche or address a highly specific problem. They are typically not applicable to different situations and are instead narrowly tailored in form and function.

Additionally, current hitch adapters do not provide a desirable quantity and orientation of contact points to afford connection options for users wishing to secure different types of equipment and cargo to their truck beds. For example, when transporting 1 or 2 dirt bike(s), ATV(s), etc. in the bed of a truck, there is no easy, convenient way to secure the back of the vehicle(s). When transporting an extension ladder in the bed of a truck already equipped with a 5^{th} wheel ball hitch, current technologies do not afford a quick and secure latch point. What is needed is a hitch adapter that is broadly applicable to many situations, and which provides the desired connection and securement options for users to secure various equipment and cargo to their truck beds.

The present disclosure resolves the forgoing issues by introducing a unique structure and design of a hitch adapter. The hitch adapter provides a quick, convenient, and secure attachment point that is engageable to a hitch and provides alternative points of engagement for securing equipment to the hitch adapter.

### II. SUMMARY

Provided is a hitch adapter including a base plate having an outer edge portion, an interior portion, at least one anchor point for use in securing at least one associated object to the hitch adapter, and an opening; and a latch plate positioned over or under the base plate such that the latch plate is selectively positionable with respect to the opening on the base plate between an open position and a closed position.

According to further aspects of the present teaching, the base plate further includes at least one connection point disposed radially with respect to a center point on the base plate; the latch plate further includes at least one connection point corresponding to the at least one connection point on the base plate for securing the latch plate to the base plate; and the hitch adapter includes fasteners disposed within the corresponding connection points on the base plate and the latch plate to secure the latch plate to the base plate.

According to further aspects of the present teaching, the base plate includes a cutout that forms the base plate opening, wherein the cutout is formed from any number of straight or curved lined cuts in the interior portion of the base plate.

According to further aspects of the present teaching, the cutout forms a curvilinear opening in the interior portion of the base plate.

According to further aspects of the present teaching, the curvilinear opening is continuously curved.

According to further aspects of the present teaching, the cutout includes two sub-cutouts, wherein the first sub-cutout includes a first semicircular cutout and the second sub-cutout includes a second semicircular cutout, wherein the first semicircular cutout and the second semicircular cutout are overlapping.

According to further aspects of the present teaching, the latch plate is pivotably disposed over the opening the base plate.

According to further aspects of the present teaching, the latch plate is selectively pivotable between a fully open position wherein the first semicircular cutout and the second semicircular cutout are not covered by the latch plate and a closed position wherein a portion of the cutout is covered by the latch plate.

According to further aspects of the present teaching, the first semicircular cutout has a first radius, and the second semicircular cutout has a second radius and wherein the second radius is less than the first radius.

According to further aspects of the present teaching, the first semicircular cutout is disposed concentrically with the center point in the base plate.

According to further aspects of the present teaching, the latch plate includes a latch semicircular cutout having a third radius, wherein the third radius is equal to the second radius of the second semicircular cutout of the base plate.

According to further aspects of the present teaching, the base plate further includes: a first anchor point positioned at a first end of the base plate and a second anchor point positioned at a second end of the base plate and disposed opposite the first anchor point, wherein the first and second semicircular cutouts are disposed between the first anchor point and the second anchor point.

According to further aspects of the present teaching, the base plate and the latch plate each include corresponding slide connection points and corresponding pivot connection points, wherein the pivot connection points between the base plate and the latch plate allow for rotational movement of the latch plate with respect to the base plate, and wherein the corresponding slide connection points are disposed a circumferential distance from the pivot connection points and a radial distance with respect to the center point of the base plate.

According to further aspects of the present teaching, the latch plate or the base plate includes a slide channel cut circumferentially into the latch plate or the base plate for receiving a slide connection pin, wherein the slide channel and the slide connection pin provides the slide connection points between the latch plate and the base plate and wherein the slide connection points are disposed along the slide channel.

According to further aspects of the present teaching, the latch cutout is disposed concentrically with the second semicircular cutout when the latch plate is in the closed position.

According to further aspects of the present teaching, the latch plate is retained in the closed position using a fastener.

According to further aspects of the present teaching, the hitch adapter includes a circular base plate; and at least two anchor points disposed circumferentially and equidistantly around the center point of the base plate.

According to further aspects of the present teaching, the anchor points include segmented edges formed from openings within the base plate.

According to further aspects of the present teaching, the hitch adapter includes four anchor points.

According to further aspects of the present teaching, the first and second semicircular cutouts are disposed centrally on the base plate with respect to the anchor points.

Other benefits and advantages of this invention will become apparent to those skilled in the art to which it pertains upon reading and understanding of the following detailed specification.

### III. BRIEF DESCRIPTION OF THE DRAWINGS

The disclosed hitch adapter may take physical form in certain parts and arrangement of parts, embodiments of which will be described in detail in this specification and illustrated in the accompanying drawings which form a part hereof and wherein:

FIG. 1 is a perspective view of an assembled hitch adapter that is secured around an exemplary ball hitch.

FIG. 2 is a top view of an exemplary base plate of a hitch adapter.

FIG. 3 is a top planar view of exemplary latch plate of a hitch adapter.

FIG. 4 is a perspective view of an exemplary hitch adapter in assembled form secured around a ball hitch.

FIG. 5 is a perspective view of an alternative embodiment of an exemplary hitch adapter secured around a ball hitch.

### IV. DETAILED DESCRIPTION

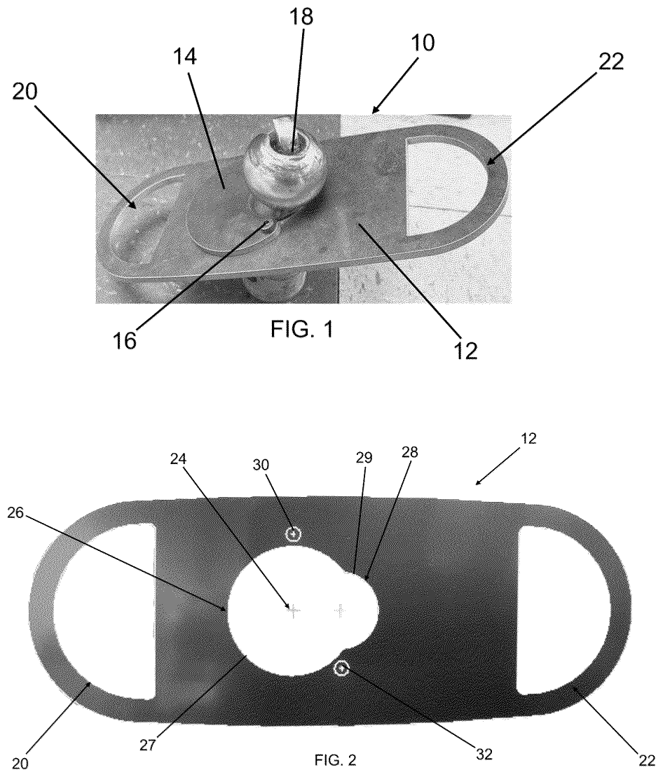

Referring now to the drawings, which are presented for purposes of illustrating embodiments of the hitch hook only and not for purposes of limiting the same, and wherein like reference numerals are understood to refer to like components. FIG. 1 shows a hitch hook (also referred to as a “hitch adapter” or a “hitch hook adapter”) 10 according to some embodiments of the present subject matter. The hitch hook 10 may be used for securing cargo, dirt bikes, all-terrain vehicles (ATVs), and other equipment to hitches on vehicles using tie-downs (e.g., a strap, rope, cord or any type of fastening device). The hitch hook 10 may be utilized with hitches present on any vehicle, including but not limited to trucks, tow boats, and other modes of transport.

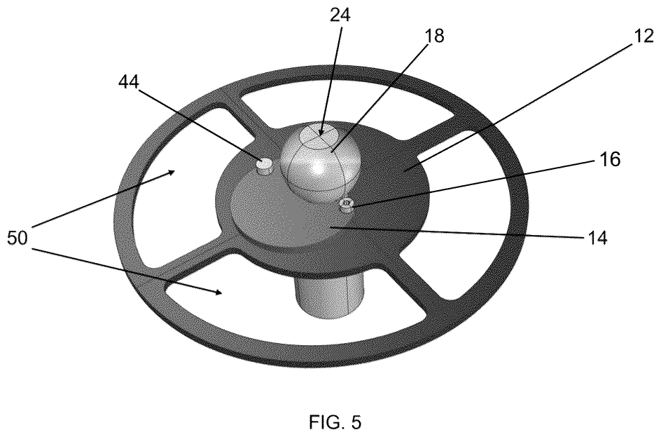

With reference to FIGS. 2 and 5, the hitch hook 10, referred to as hitch adapter 10 below, includes a base plate 12 and a latch plate 14. The latch plate 14 may be disposed either on a top side or a bottom side of the base plate 12. According to certain aspects of the present teaching, the latch plate 14 is disposed on the top side of the base plate 12, i.e., over a top portion of the base plate 12. With reference to FIG. 2, the base plate 12 includes a first anchor point 20 and a second anchor point 22. However, in other embodiments, the base plate 12 may include any number of anchor points (e.g., a single anchor point or a plurality of anchor points). Anchor points may be solid sections disposed on the edges of voids in the base plate 12 (i.e., edges formed from openings in the base plate), whereby hooks, ropes, cords, or other securement devices may be affixed. In a particular embodiment, the anchor points 20, 22 may include a first anchor point 20 and a second anchor point 22, which may be disposed opposite each other at opposing sides or ends of the base plate 12. In another embodiment, the anchor points 50 may be disposed radially about a center point 24 as shown in FIG. 5.

The base plate further includes a cutout that may be of any shape and that may be formed from any number of straight or curved lined cuts in an interior portion of the base plate. According to certain aspects of the present teaching, the cutout forms at least one curved line in the interior portion of the base plate. The cutout may also be described as forming a curvilinear opening in the interior portion of the base plate in that the opening is bounded by at least one curved line. In certain embodiments, the at least one curved line or alternatively, the curvilinear opening in the base plate formed by the cutout is continuous in nature. In further embodiments, the cutout forms a single continuous curved line or continuous curvilinear opening in the base plate. More specifically, in further embodiments, the cutout may be formed by two sub-cutouts, i.e., a first cutout and a second cutout. According to certain aspects of the present teaching, the first and second cutouts may be circular or semicircular in shape. However, it is to be understood that the cutouts may form any shape.

With further reference to FIG. 2, the base plate 12 includes two overlapping sub-cutouts, i.e., a first semicircular cutout 26 and a second semicircular cutout 28. By semicircular, it is meant that the shape of the circumference of the cutout is less than a full or complete circle. By overlapping, it is meant that a portion of the circumference of the first semicircular cutout 26 constitutes a phantom edge that lies within the opening of the second semicircular cutout 28 that would, if present, result in the first semicircular cutout 26 forming a complete circle. By overlapping, it is also meant that a portion of the circumference of the second semicircular cutout 28 constitutes a phantom edge that lies within the opening of the first semicircular cutout 26 that would, if present, result in the second semicircular cutout 28 forming a complete circle. It is noted that FIG. 5 may include a similar structure described above with respect to the first semicircular cutout 26 and the second semicircular cutout 28. With further reference to FIG. 2, the base plate 12 and the first 26 and second 28 semicircular cutouts may be disposed between the first 20 and second 22 anchor points.

With further reference to FIGS. 2 and 5, the first semicircular cutout 26 may be disposed concentrically with a center point 24. The second semicircular cutout 28 may at least partially overlap with the first cutout 26. The center of a ball hitch 18 positioned within the opening formed by the first 26 and second 28 semicircular cutouts may also represent the center point 24 of the base plate 12 when fully engaged. The first cutout 26 may have a first radius 27, and the second cutout 28 may have a second radius 29. The second radius 29 may be less than the first radius 27. The base plate may further include at least one connection point. In the embodiments shown in FIGS. 2 and 5, the base plate 12 includes a first connection point 30 and a second connection point 32. The connection points 30, 32 may be disposed radially about the center point 24 of the base plate 12. In a particular embodiment, the first connection point 30 may be a slide connection point 30 and the second connection point may be a pivot connection point 32. The pivot connection point 32 may be disposed a circumferential distance from the slide connection point 30. The slide connection point 30 and pivot connection point 32 may operate to secure the base 12 and latch 14 plates together and engage a latching operation, as described in further detail below. The base plate 12 may be oblong (as shown for example in FIG. 2), circular (as shown for example in FIG. 5), or any other shape chosen according to the engineering judgment of a person of ordinary skill in the art.

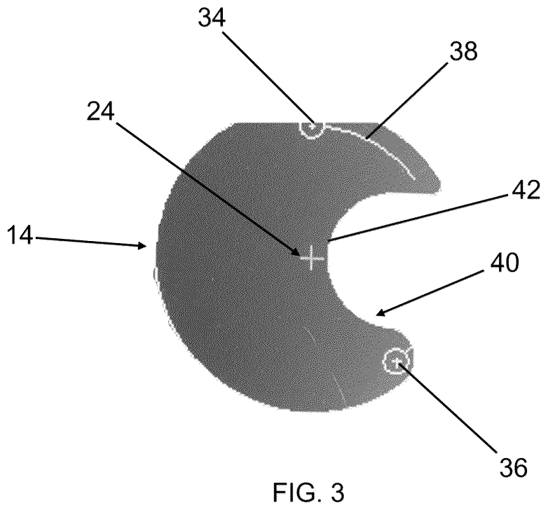

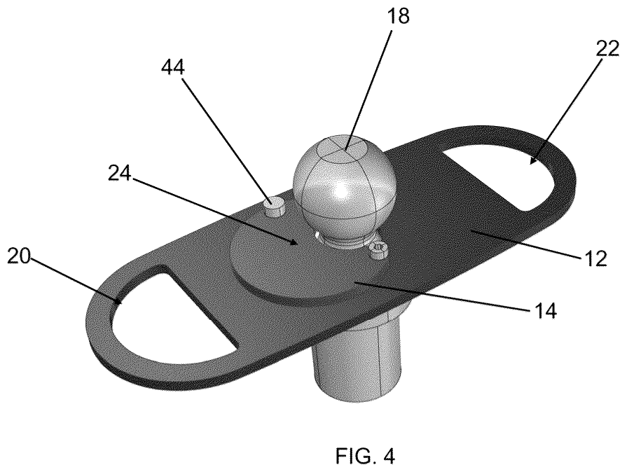

With reference to FIG. 3, the latch plate 14 may include a latch semicircular cutout 40 having a third radius 42, at least one connection point, and a slide channel 38. (it is noted that in other embodiments, the slide channel may be present within the base plate as opposed to the latch plate and the latch plate may include a connection point secured within the slide channel of the base plate). By semicircular, it is meant that the shape of the circumference of the latch plate 14 cutout 40 is less than a full or complete circle. The third radius 42 of latch cutout 40 may be equal to the second radius 29 of the second semicircular cutout 28. The number of connection points on the latch plate 14 may be equal to the number of connection points on the base plate 12 and the locations of the latch plate connection points may correspond to the locations of the base plate connection points. In the embodiments shown in FIGS. 1-5, the latch plate may include a first connection point 34 and a second connection point 36 which corresponds to the first connection point 30 and the second connection point 32 on the base plate 12. In a particular embodiment, the latch plate connection points 34, 36 may be disposed radially about the center point 24. The latch plate 14 may include a slide connection point 34, a slide channel 38 and a pivot connection point 36 disposed a circumferential distance from the slide connection point 34. The slide channel 38 may be cut circumferentially into the latch plate 14, typically along the edge of the latch plate 14, but it may be cut in any location chosen with sound engineering judgement. The slide connection point 34 may be disposed along the slide channel 38. In certain embodiments, the base plate connection point 30 on the base plate 12 may constitute a fastener such as a post or a pin (or any other suitable fastener) that fits within the slide channel 38 of the latch plate 14. In a particular embodiment, the latch plate 14 may be circular and disposed concentrically with the center point 24. It is noted, however, that in other embodiments, the slide channel may be present within the base plate as opposed to the latch plate and the latch plate may include a connection point to secure the latch plate to the slide channel of the base plate. Moreover, in other embodiments, in other embodiments both the base plate 12 and the latch plate 14 may include corresponding slide channels 38 that overlap one another when the base plate 12 and the latch plate 14 are positioned over or under one another allowing for insertion of a fastener (e.g., a bolt, a pin or any other suitable fastener within the purview of a person of ordinary skill in the art) within the slide channels 38 to provide connection point 34.

With reference to FIG. 5, the base plate 12 may be circular in shape. In a particular embodiment, the circular base plate 12 may have anchor points 50, which may be solid sections disposed on the edges of voids around the perimeter of the circular base plate 12 (i.e., edges formed from openings in the base plate), whereby hooks, ropes, cords, or other securement devices may be affixed, disposed radially about a center point 24. The latch plate 14 may be configured to pivot about pivot connection points between an open position and a closed position. The center of the ball hitch 18 may represent the center point 24. Also, the cutouts (e.g., first and second semicircular cutouts or any other shaped cutouts disclosed herein) in the embodiment of FIG. 5 (not shown in FIG. 5) may be disposed centrally on the base plate with respect to the anchor points.

With reference to FIGS. 1, 2, 3, & 4, the various components of the hitch adapter 10 may function together to engage a latching operation that secures the adapter 10 to a hitch 18. An exemplary hitch 18 that the hitch adapter 10 may engage is ball hitch 18 although the hitch adapter 10 is contemplated for use with any type of hitch. The hitch upon which the hitch adapter is secured may be located on the rear bed of a truck, the back of an aquatic tow vehicle, the underside of a truck, or any other location chosen according to sound engineering judgement of a person of ordinary skill in the art. The base plate 12 and latch plate 14 may be secured together at the slide connection points 30, 34 and the pivot connection points 32, 36, using pins or any other fastener within the sound engineering judgement of a person of ordinary skill in the art (shown, for example, in FIG. 1 as 16). The latch plate 14 may be configured to pivot about the pivot connection points 32, 36 between an open position and a closed position. The latch plate 14 may interact with the base plate 12 to enclose and capture the hitch 18 mounted to the mode of transport. The hitch 18 may include a ball and a stem positioned between a proximal end and a distal end of the hitch, and the hitch adapter 10 open position may allow the ball of the hitch to pass through the opening formed in the cutout of the base plate 12 (e.g., the first and second semicircular cutouts 26, 28). The hitch adapter 10 may then be lowered over the hitch 18 and the latch plate 14 positioned into a closed position where the latch plate 12 encloses the stem of the hitch. While in this closed position, the latch plate 14 abuts the stem of the hitch and the ball of the hitch is mechanically blocked by the latch plate 14 and cannot pass through the opening formed by the cutout in the base plate 12. Once the hitch adapter 10 is installed, ropes, chains, bungee cords, ratcheting or winch straps, or any tie-down equipment chosen may be knotted, tied, clamped, hooked, or otherwise secured to the anchor points 20, 22, (as shown in FIGS. 1, 2 and 4) or 50 (as shown in FIG. 5) of the hitch adapter 10. By looping, tying, or otherwise securing the tie-down equipment to cargo, dirt bikes, ATVs, and other equipment and objects, the equipment or object may be effectively secured to the hitch adapter 10—which itself may be secured to the hitch 18 (positioned on the associated vehicle) in the manner described above.

In a particular embodiment, beginning in the open position, and while in the open position, the latch plate 14 is in a position such that both the first 24 and second 28 semicircular cutouts uncovered. While in the open position, a ball hitch 18 may be inserted through the first semicircular cutout 24 with cutout first radius 27 being large enough to encompass the ball hitch 18. After passing the ball hitch through the first cutout 24, the user rotates the latch plate 14 along its connection points to the base plate 12 around the stem of the ball hitch 18. While in the closed position, the latch plate 14 covers at least a portion of the opening of the first semicircular cutout 24 but leaves at least a portion of the opening of the second semicircular cutout 28 uncovered. The second radius 29 of the second cutout 28 is not sufficiently large to allow the head of the ball hitch 18 to pass through, thus capturing the stem of the ball hitch 18 and latching the ball hitch 18 and hitch adapter 10 together. The latch cutout 40 may be disposed concentrically with the second semicircular cutout 28 when the latch plate 14 is in the closed position. The latch plate 14 may then be secured and retained in a closed position with a latch pin 44 or with any type of suitable fastener including but not limited to a bolt, a bolt and nut, a latch, or any other fastening mechanism chosen according to the sound engineering judgement of a person of ordinary skill in the art.

While the hitch hook provided herein has been described in connection with various illustrative embodiments, it is to be understood that other similar embodiments may be used, or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the hitch hook should not be limited to any single embodiment, but rather construed in breadth and scope in accordance with the recitations of the appended claims.

Having thus described the hitch hook disclosed herein, it is now claimed:

What is claimed:

1. A hitch adapter comprising:
a base plate having:
an outer edge portion,
an interior portion,
at least one anchor point for use in securing at least one associated object to the hitch adapter, and
an opening; and,
a latch plate positioned over or under the base plate such that the latch plate is selectively positionable with respect to the opening on the base plate between an open position and a closed position.

2. The hitch adapter of claim 1 wherein:
the base plate further comprises at least one connection point disposed radially with respect to a center point on the base plate;
the latch plate further comprises at least one connection point corresponding to the at least one connection point on the base plate for securing the latch plate to the base plate; and
fasteners disposed within the corresponding connection points on the base plate and the latch plate to secure the latch plate to the base plate.

3. The hitch adapter of claim 2, wherein the base plate comprises a cutout that forms the base plate opening, wherein the cutout is formed from any number of straight or curved lined cuts in the interior portion of the base plate.

4. The hitch adapter of claim 3, wherein the cutout forms a curvilinear opening in the interior portion of the base plate.

5. The hitch adapter of claim 4, wherein the curvilinear opening is continuously curved.

6. The hitch adapter of claim 5, wherein the cutout comprises two sub-cutouts, wherein the first sub-cutout comprises a first semicircular cutout and the second sub-cutout comprises a second semicircular cutout, wherein the first semicircular cutout and the second semicircular cutout are overlapping.

7. The hitch adapter of claim 6 wherein the latch plate is pivotably disposed over the opening the base plate.

8. The hitch adapter of claim 7, wherein the latch plate is selectively pivotable between a fully open position wherein the first semicircular cutout and the second semicircular cutout are not covered by the latch plate and a closed position wherein a portion of the cutout is covered by the latch plate.

9. The hitch adapter of claim 8 wherein the first semicircular cutout has a first radius, and the second semicircular cutout has a second radius and wherein the second radius is less than the first radius.

10. The hitch adapter of claim 9, wherein the first semicircular cutout is disposed concentrically with the center point in the base plate.

11. The hitch adapter of claim 10, wherein the latch plate comprises a latch semicircular cutout having a third radius, wherein the third radius is equal to the second radius of the second semicircular cutout of the base plate.

12. The hitch adapter of claim 11, wherein the base plate further comprises:
a first anchor point positioned at a first end of the base plate and a second anchor point positioned at a second end of the base plate and disposed opposite the first anchor point,
wherein the first and second semicircular cutouts are disposed between the first anchor point and the second anchor point.

13. The hitch adapter of claim 12:
wherein the base plate and the latch plate each comprise corresponding slide connection points and corresponding pivot connection points,
wherein the pivot connection points between the base plate and the latch plate allow for rotational movement of the latch plate with respect to the base plate, and
wherein the corresponding slide connection points are disposed a circumferential distance from the pivot connection points and a radial distance with respect to the center point of the base plate.

14. The hitch adapter of claim 13:
wherein the latch plate or the base plate comprises a slide channel cut circumferentially into the latch plate or the base plate for receiving a slide connection pin,
wherein the slide channel and the slide connection pin provide the slide connection points between the latch plate and the base plate and wherein the slide connection points are disposed along the slide channel.

15. The hitch adapter of claim 14, wherein the latch cutout is disposed concentrically with the second semicircular cutout when the latch plate is in the closed position.

16. The hitch adapter of claim 15, wherein the latch plate is retained in the closed position using a fastener.

17. The hitch adapter of claim 14 further comprising:
a circular base plate; and
at least two anchor points disposed circumferentially and equidistantly around the center point of the base plate.

18. The hitch adapter of claim 17, wherein the anchor points comprise segmented edges formed from openings within the base plate.

19. The hitch adapter of claim 18 comprising four anchor points.

20. The hitch adapter of claim 17, wherein the first and second semicircular cutouts are disposed centrally on the base plate with respect to the anchor points.
